(19) United States
(12) Patent Application Publication
(10) Pub. No.: US 2022/0412871 A1
(43) Pub. Date: Dec. 29, 2022

(54) DEVICE FOR VISUALIZATION OF COMPONENTS IN A BLOOD SAMPLE

(71) Applicant: Siemens Healthcare Diagnostics Inc., Tarrytown, NY (US)

(72) Inventor: Mohiudeen Azhar, Needham, MA (US)

(73) Assignee: Siemens Healthcare Diagnostics Inc., Tarrytown, NY (US)

(21) Appl. No.: 17/756,860

(22) PCT Filed: Dec. 4, 2020
(86) PCT No.: PCT/US20/63312

§ 371 Date: Jun. 3, 2022

Related U.S. Application Data
(60) Provisional application No. 62/946,068, filed on Dec. 10, 2019.

(51) Int. Cl. G01N 15/14; B01L 3/00; G02B 21/08; G02B 21/00

(52) U.S. Cl. CPC G01N 15/1434; B01L 3/502761; G02B 21/086; G02B 21/0004; B01L 2200/0652; B01L 2300/088; B01L 2400/086; G01N 15/1484; G01N 2015/0065

(57) ABSTRACT

A device (100) for visualization of one or more components in a blood sample is disclosed. In one aspect, the device (100) includes an imaging module (110), wherein the imaging module (110) includes a controllable illumination source (102) capable of emitting light in plurality of discrete angles; a tube lens (105); one or more objective lens (104); and an image capturing module (106). Additionally, the device (100) includes a channel (103) configured to carry the blood sample, wherein the channel (103) is capable of sorting the one or more components in the blood sample.

This application claims priority to U.S. Provisional Application No. 62/946,068, filed on Dec. 10, 2019. The entire content of the above-referenced patent application is hereby expressly incorporated herein by reference.

### FIELD OF TECHNOLOGY

The present disclosure relates to the field of analysis of a sample and more particularly to the field of visualization of components in a blood sample.

### BACKGROUND

Analysis of blood samples, for example blood smears, is performed to determine one or more characteristics associated with the blood sample. Such characteristics may include determination of number of White Blood Cells (WBCs) and Red Blood Cells (RBCs) in the blood sample. Currently, analysis of blood smears is performed using microscopes manually or with automated microscopic slide scanners. Automated slide scanners enable automation of scanning workflow of microscopic slides. The scanners may raster scan a given area on a microscopic slide containing the blood smear. Such scanning of microscopic slides involves use of a high magnification/resolution microscope objective lens, for example 40× or 100× objective lens. In some cases, immersion oil may also be used to improve the magnification. Such configuration of the microscope is chosen because the number of White Blood Cells (WBCs) is sparse compared to Red Blood Cells (RBCs) with about one WBC for every 600-1000 RBCs. As increase in magnification decreases the field of view of the microscope, the microscopic slides may have to be scanned for a longer period of time and also several times to accurately determine the number of RBCs and WBCs. Furthermore, there is no way of easily sorting the blood cells that allows for easier and faster counting of blood cells. Therefore, manual scanning of slides under the microscope can be a time consuming and labor intensive process. Additionally, automated slide scanners include precision mechanical components and therefore are expensive.

Thus, there is no way of visualizing blood cells in a wide field of view with high resolution that is inexpensive and fast. Traditional imaging techniques also do not provide a way of computationally improving image resolution of the microscopic slide. Therefore, there exists a need for an efficient way of visualizing a blood sample that offers a wide field of view and enables faster sorting of blood cells.

### SUMMARY

A device for visualization of one or more components in a blood sample is disclosed. In one aspect of the invention, the device includes an imaging module. The imaging module includes a controllable illumination source which is capable of emitting light in plurality of discrete angles. The imaging module further includes a tube lens, one or more objective lens and an image capturing module. Additionally, the device includes a channel configured to carry the blood sample, wherein the channel is capable of sorting the one or more components in the blood sample.

This summary is provided to introduce a selection of concepts in a simplified form that are further described below in the following description. It is not intended to identify features or essential features of the claimed subject matter. Furthermore, the claimed subject matter is not limited to implementations that solve any or all disadvantages noted in any part of this disclosure.

### BRIEF DESCRIPTION OF THE DRAWINGS

The present invention is further described hereinafter with reference to illustrated embodiments shown in the accompanying drawings, in which:

FIG. 1 illustrates an imaging module for visualizing one or more components on a microscopic slide, according to an embodiment.

FIG. 2 illustrates a channel configured to carry and sort one or more components in a blood sample, according to an embodiment.

FIG. 3 illustrates a channel configured to carry and sort one or more components in a blood sample, according to another embodiment.

### DETAILED DESCRIPTION

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure. Disclosed embodiments provide device for analyzing an image. In particular, the device may enable visualization of one or more components in a blood sample.

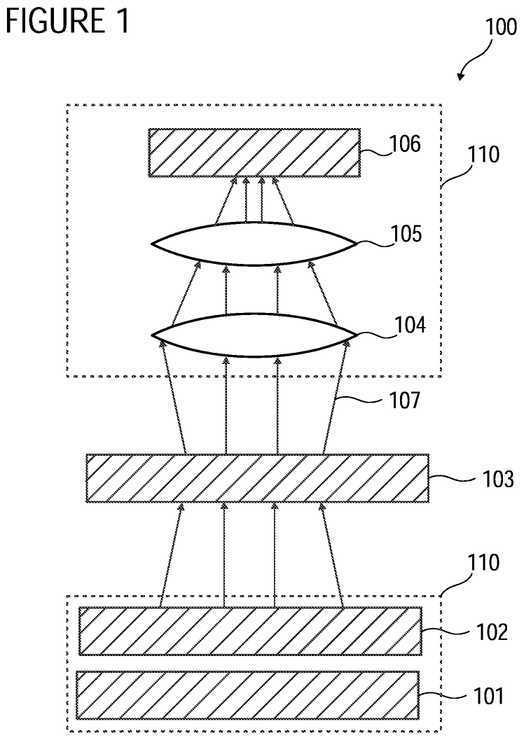

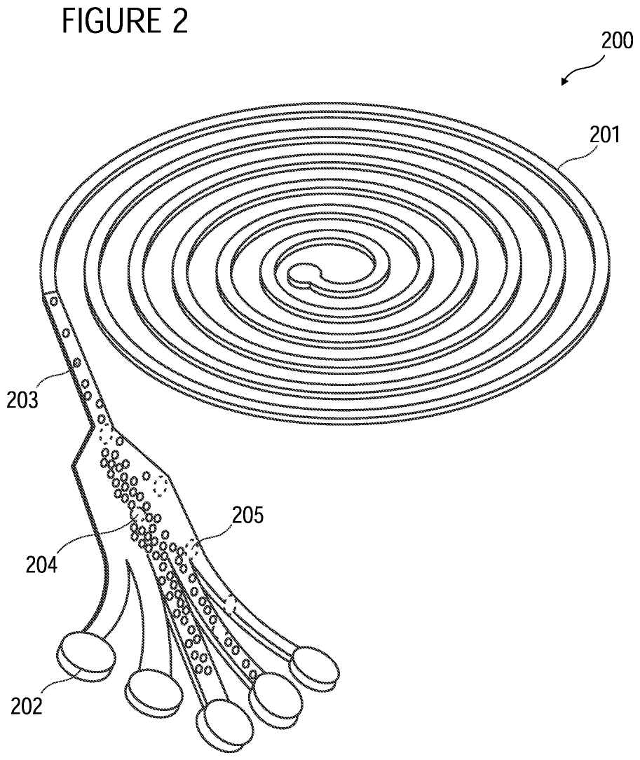

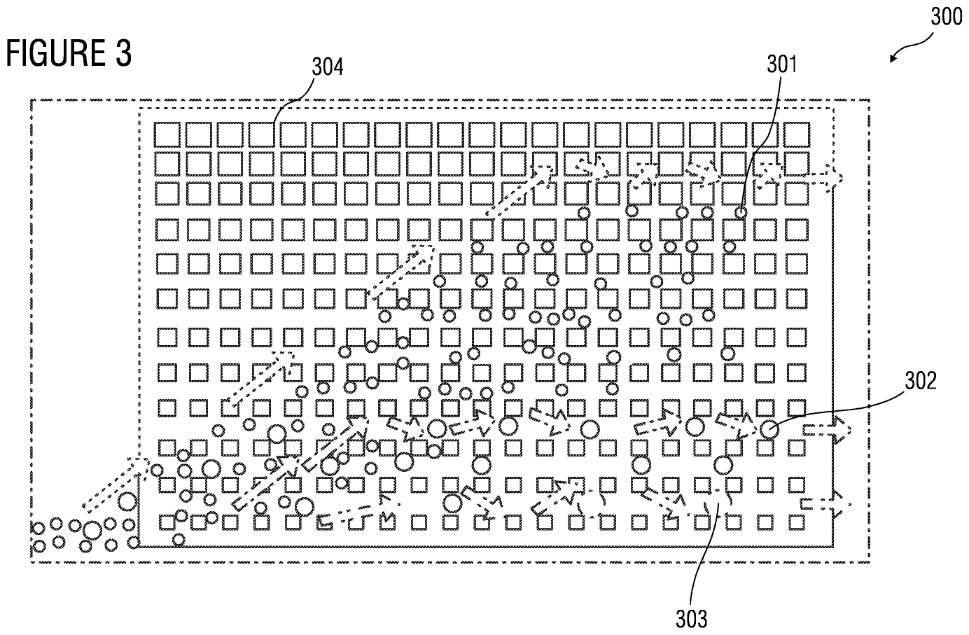

FIG. 1 illustrates an embodiment of device 100 including an imaging module 110 for visualizing one or more components of a blood sample. The imaging module 110 includes a light source 102 coupled to a processor 101. The light source 102 may be a multi-wavelength light source, i.e. capable of emitting light of varying wavelengths. In an embodiment, the light source 102 is configured to emit light of at least three different wavelength ranges. The wavelength ranges of the light source 102 may be, for example, between 400 nm and 420 nm; 440 nm and 480 nm; and 520 nm and 650 nm. In an embodiment, the light emitted 107 from the light/illumination source 102 passes through a channel 103 which includes one or more components to be imaged. The channel 103 may be, for example, a microfluidic channel capable of carrying the blood sample including a plurality of RBCs and WBCs. Embodiments of the microfluidic channel 103 are explained in further detail in FIGS. 2 and 3. The imaging module 110 further includes an objective lens 104 to visualize and magnify the one or more components in the microfluidic channel 103. The light 107 from the light/illumination source 102 radiates on to the microfluidic channel 103. In an embodiment, the imaging module 110 may additionally include a tube lens 105. The tube lens 105 is used in microscopes to enable creation of real images from intermediate images placed at infinity. Therefore, tube lens 105 enable visualization of infinity corrected images. The imaging module 110 may also include an imaging capturing module 106. The image capturing module 106 may include imaging lenses and an imaging sensor, configured to capture an image of the illuminated microfluidic channel 103. The imaging sensor may be, for example a charge-coupled device (CCD) or a complementary metal oxide semiconductor (CMOS). In an embodiment, the image capturing module 106 is also configured to transfer the captured image to a server for further processing.

In an embodiment, the imaging module 110 is a Fourier ptychography microscope. Fourier ptychography is a computational imaging technique where phase information associated with the one or more components on the microscopic slide can be computationally derived. Phase information is a representation of refractive index changes observed when light 107 passes through the one or more components in the microfluidic channel 103. Phase information of the one or more components can be used to differentiate areas of enhanced density or refractive index in the microfluidic channel 103, such as nuclei of WBCs. Red blood cells (RBCs) and WBCs have unique phase profiles owing to the morphological differences between the cells. Such differences in phase information can be used to identify cell features such as nuclei of WBCs. Fourier ptychography microscopy provides for a wide field of view and high resolution imaging. Wide field of view enables visualizing more blood cells at a given point in time. Therefore, analysis of the microfluidic channel 103 is faster and simpler. As Fourier ptychography microscopy enables illumination of the microfluidic channel 103 at different angles, high diffraction orders of the blood sample can be collected. Such diffraction orders can be computationally combined to obtain a high resolution image without compromising on the field of view. Such high resolution image is obtained with a high depth of field and without a need for immersion oil to improve magnification.

In Fourier ptychography microscopy, phase information can also be derived computationally from one or more images of the one or more components in the blood sample illuminated at varying illumination angles. Such computational derivation of phase information may be performed using Gerchberg-Saxton algorithm. The phase image obtained from the algorithm enables calculation of key clinical hematological parameters such as hemoglobin concentration and mean corpuscular volume from cell thickness/height. A relationship between phase shift (Δϕ), concentration (C) and height (h) with a spatial dependence in a two-dimensional (x, y) plane is depicted below:

Δϕ(x,y;λ)=k₀[β(λ)C(x,y)+Δn_{ws}(λ)]h(x,y)

where λ is wavelength of light, Δn_{ws} is refractive index difference between water and surrounding media, and β is the rate of change (mg/l) of the refractive index versus protein concentration. Fourier ptychography provides several unique technical advantages over traditional microscopy. Fourier ptychography enables a wide field of view with high resolution using a low magnification/resolution lens or objective lens. The hardware components of Fourier ptychography microscope are simple and mainly require an illumination source which can illuminate at multiple angles. Additionally, Fourier ptychography enables obtaining phase images at multiple wavelengths computationally using image reconstruction algorithms such as Gerchberg-Saxton algorithm.

FIG. 2 illustrates a channel 200 configured to carry and sort one or more components in a blood sample, according to an embodiment. The channel 200 is a spiral microfluidic channel 200 including a spiral portion 201 and a plurality of outlets 202. In an embodiment, the microfluidic channel 200 may have a depth in the range between 100 and 200 μm. The channel 200 may be composed of a transparent medium, for example, glass and includes an outer surface and an inner surface. A flow of the blood sample may be introduced in the channel 200 at the center of the spiral portion 201. The one or more components in the blood sample, i.e. the RBCs and the WBCs experience inertial lift forces in the spiral portion 201 which arise from a parabolic nature of laminar velocity profile in a Poiseuille flow. Such inertial lift forces cause the one or more components in the blood sample to migrate away from a center of the channel 200 and along a perimeter of the channel 200. Curvature of the channel 200 introduces a transverse Dean flow. Such Dean flow is a secondary rotational flow that is perpendicular to the main flow direction of the blood sample in the channel 200. Therefore, two symmetric counter-rotating vortices may be created on a top surface and a bottom surface of a cross-sectional plane of the channel 200. A drag force is introduced by such vortices thereby causing the one or more components of the blood sample to move along the Dean flow. Therefore, based on the position of the one or more components in the channel 200, the one or more components migrate towards the inner surface of the channel 200 or continue to flow along the vortices. The inertial lift forces and the drag forces act in opposite directions near the inner surface of the channel 200 thereby creating an equilibration and channeling the one or more components in the blood sample into a single stream. The ratio of the inertial lift force to drag force may depend on size of the one or more components of the blood sample, the one or more components with a greater diameter equilibrate at distinct positions. Therefore, components of different sizes are separated out. In an embodiment, the one or more components 204 with a greater diameter, for example WBCs, equilibrate at a position close to the inner surface of the channel 200 and the one or more components 203, 205 with a smaller diameter equilibrate at a position away from the inner surface of the channel 200.

In an embodiment, the spiral portion 201 of the channel 200 may have five or more loops. The loops may be spaced in the range of, for example, 400-1000 μm. The channel 200 may have a width in the range of, for example, 300 to 600 μm. The plurality of outlets 202 is configured to collect the cone or more components of the blood sample after they are separated in the spiral portion 201. Advantageously, the channel 200 sorts the one or more components in the blood sample, thereby eliminating the need to scan the field of view for required components.

FIG. 3 illustrates another embodiment of a channel 300 configured to carry and sort the one or more components of the blood sample. The channel 300 may be a microfluidic channel 300 or a microfluidic chip composed of glass or silicon. The depth and width of the microfluidic chip 300 may be in the range of, for example, 100 to 200 μm and 300 to 500 μm respectively. The microfluidic chip 300 may include an upper surface and a bottom surface, one or more inlets and one or more outlets. The microfluidic chip 300 may include a plurality of microposts 304 connected to the bottom surface of the microfluidic chip 300. Such microposts 304 may vary in size and distance, for example distance between a first set of microposts may be greater in comparison to distance between a second set of microposts. In an embodiment, the distance between the microposts 304 may progressively increase from an upper part of the microfluidic chip 300 to a lower part of the microfluidic chip 300. The distance between the microposts may be in the range of, for example, 10 μm to 2 μm. Therefore, the difference in distance between the microposts 304 enables sorting of the one or more components 301, 302, 303 in the blood sample according to the size of such one or more components. Ratcheting effect may be used to separate the one or more components in the blood sample. This involves selectively transporting the one or more components in the blood sample through the microfluidic chip 300. Smaller and more deformable components 301 flow across smaller microposts 304 during forward flow of the blood sample in the microfluidic chip 300. Thus, a reverse flow of the blood sample is avoided. Larger and less deformable components 302, 303 are trapped by the microposts 304 and are released with each reverse flow of the blood sample.

The blood sample may be introduced into the microfluidic chip 300 through the inlet at a bottom-left corner of the microfluidic chip 300. The one or more components in the blood sample follow a diagonal path in the microfluidic chip 300 through combined oscillatory flow and cross flow. Small components, for example RBCs, flow into the outlet at a top corner of the microfluidic chip 300 while the bigger components, for example WBCs, are restricted due to the size and deformability. Therefore, each type of component is directed to a specific outlet. Advantageously, the one or more components in the blood sample are sorted before being analyzed/visualized by the imaging module 110.

The image capturing module 106 may be used to capture one or images of the sorted one or more components in the channel 300. Such images may be processed further to identify the one or more components in the blood sample. In an embodiment, a first threshold associated with the one or more components in the image is identified. The first threshold may be, for example, size of the one or more components in the image. WBCs are bigger in size in comparison to RBCs. Therefore, the first threshold is set such that the WBCs are separated out from the RBCs efficiently. The size of the one or more components may be determined, for example, based on the area or circumference of the components in the image. Such determination may be based on the pixel intensity values associated with cellular boundaries of the one or more components in the image. Advantageously, the device 100 enables accurate identification of components in the image which are of clinical relevance.

The above invention enables visualization of one or more components in the blood sample, in a field of view in the range of, for example, 2000×2000 micron. This eliminates the need for manual or automated scanning of the microfluidic channel 103, 200, 300. The device 100 allows for computational adjustment of focus after images of the one or more components in the blood sample are acquired. Advantageously, the device 100 enables analysis of significantly greater number of components in the blood sample in comparison to devices available in the prior art. Furthermore, the one or more components in the blood sample may be visualized in a single field of view without a requirement of physical scanning of the microfluidic channel.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A device for visualization of one or more components in a blood sample, the device comprising:
an imaging module, wherein the imaging module comprises:
a controllable illumination source capable of emitting light in plurality of discrete angles;
a tube lens;
one or more objective lens; and
an image capturing module; and
a channel configured to carry the blood sample, wherein the channel is capable of sorting the one or more components in the blood sample.

2. The device according to claim 1, wherein the channel is a microfluidic channel.

3. The device according to claim 1, wherein the channel is a spiral microfluidic channel.

4. The device according to claim 1, wherein the channel is a microfluidic chip comprising a plurality of arrays of microposts.

5. The device according to claim 1, wherein the illumination source is configured to emit light at wavelengths in the range between 400 nm to 420 nm, and/or 440 nm to 480 nm, and/or 520 nm to 650 nm.

6. The device according to claim 1, wherein a depth of the channel is in the range between 100 and 200 μm.

7. The device according to claim 1, wherein the image capturing module comprises one or more lenses and an imaging sensor, wherein the imaging sensor is a charge-coupled device or complementary metal oxide semiconductor.

8. The device according to claim 1, wherein the imaging module is a Fourier ptychography microscope.

9. The device according to claim 1, wherein the one or more components in the blood sample are sorted based on a size associated with the one or more components in the blood sample.
